(19) United States
(12) Patent Application Publication
(10) Pub. No.: US 2023/0266992 A1
(43) Pub. Date: Aug. 24, 2023

(54) PROCESSOR FOR MANAGING RESOURCES USING DUAL QUEUES, AND OPERATING METHOD THEREOF

(71) Applicant: Samsung Electronics Co., Ltd., Suwon-si (KR)

(72) Inventor: Soo-Young Ji, Seoul (KR)

(21) Appl. No.: 18/146,366

(22) Filed: Dec. 24, 2022

(30) Foreign Application Priority Data
Feb. 22, 2022 (KR) 10-2022-0023255

(51) Int. Cl. G06F 9/48; G06F 3/06

(52) U.S. Cl. CPC G06F 9/4831; G06F 3/0608; G06F 3/0652; G06F 3/0673

(57) ABSTRACT

A method for managing resources by using a processor that includes a first queue and a second queue includes receiving, by the processor, input/output commands from a virtual device, generating, by the processor, interrupts that each includes a process address space identifier (PASID) that corresponds to each of the input/output commands, storing, by the processor, the interrupts in the first queue, storing, by the processor, in a memory device, data that respectively corresponds to each of the interrupts, and storing, by the processor, in the second queue, location information indicating a storage location of the data stored in the memory device and size information indicating a size of the data.

### CROSS-REFERENCE TO RELATED APPLICATIONS

This application claims priority under 35 U.S.C. § 119 from Korean Patent Application No. 10-2022-0023255, filed on Feb. 22, 2022 in the Korean Intellectual Property Office, the contents of which are herein incorporated by reference in their entirety.

### TECHNICAL FIELD

Embodiments of the present disclosure described herein are directed to a processor that manages resources by using dual queues, and more particularly, to a processor that manages resources associated with an interrupt that includes a process address space identifier (PASID) that corresponds to input/output commands received from virtual devices by using dual queues, an operating method thereof, a storage medium that stores a computer program that performs the method, and a computer system that includes the processor.

### DISCUSSION OF THE RELATED ART

A virtual machine is a virtual computer created by a computer other than a physical computer. A virtual machine is a computer that is present in a computer, and implements a computing environment by using software. The virtual machine is generated through virtualization.

Virtual machines are classified into system virtual machines and process virtual machines.

A system virtual machine is also referred to as a “hardware virtual machine” and refers to a virtual machine that provides a complete system platform and supports the execution of a complete operating system (OS).

A process virtual machine is also referred to as a “language virtual machine”, an “application virtual machine”, or a “managed runtime environment”. A process virtual machine is a software simulation of a computer system. The process virtual machine provides a runtime environment that can execute a single program and supports a single process.

A virtual machine and a container refer to types of virtualization that allow an application to be deployed in an environment isolated from the underlying hardware. The container virtualizes only software above the OS level instead of virtualizing an entire computer.

### SUMMARY

Embodiments of the present disclosure provide a processor that manages resources associated with an interrupt having a process address space identifier (PASID) that corresponds to input/output commands received from virtual devices by using dual queues, an operating method thereof, a storage medium that stores a computer program that performs the method, and a computer system that includes the processor.

According to an embodiment of the present disclosure, a method for managing resources by using a processor that includes a first queue and a second queue includes receiving, by the processor, input/output commands from a virtual device, generating, by the processor, interrupts that each includes a process address space identifier (PASID) that corresponds to one of the input/output commands, storing, by the processor, the interrupts in the first queue, storing, by the processor, in a memory device, data that respectively corresponds to each of the interrupts, and storing, by the processor, in the second queue, location information that indicates a storage location of the data stored in the memory device and size information that indicates a size of the data.

According to an embodiment of the present disclosure, a processor includes a first queue and a second queue and executes a process address space identifier (PASID) allocation computer program, a first queue management computer program, and a second queue management computer program. The PASID allocation computer program receives input/output commands from virtual devices and generates interrupts that each includes a PASID that corresponds to one of the input/output commands, the first queue management computer program receives the interrupts generated by the PASID allocation computer program and stores the interrupts in the first queue, and the second queue management computer program stores in a memory device data that respectively corresponds to each of the interrupts in response to each of the interrupts received from the PASID allocation computer program or the first queue management computer program and stores in the second queue location information that indicates a storage location of the data that is stored in the memory device, and size information that indicates a size of the data.

According to an embodiment of the present disclosure, a processor includes a process address space identifier (PASID) management computer program, a second queue management computer program, a first hardware queue, and a second hardware queue. The PASID management computer program receives input/output commands from virtual devices, generates interrupts that each include a PASID that corresponds to one of the input/output commands, and stores the interrupts in the first hardware queue, and the second queue management computer program stores in a memory device data that respectively corresponds to each of the interrupts in response to each of the interrupts received from the PASID management computer program, and stores in the second hardware queue location information that indicates a storage location of the data that is stored in the memory device and size information that indicates a size of the data.

### BRIEF DESCRIPTION OF THE FIGURES

FIG. 1 illustrates an embodiment of a computer system that includes a processor that includes a PASID allocation computer program that allocates a PASID for each command, and an internal memory device, according to an embodiment of the present disclosure.

FIG. 2 illustrates an embodiment of a computer system that includes a processor that includes a PASID allocation computer program that allocates a PASID for each command, and an external memory device, according to an embodiment of the present disclosure.

FIG. 3 is a flowchart of an operation of a computer system shown in FIGS. 1, 2, 6, 7, and 8.

FIG. 4 is a flowchart of a method of calculating a weight by using a first queue management computer program executed by a processor, according to an embodiment of the present disclosure.

FIG. 5 shows an embodiment of a weight calculated by using a first queue management computer program executed by a processor, according to an embodiment of the present disclosure.

FIG. 6 illustrates an embodiment of a computer system that includes a processor that includes a PASID management computer program that allocates and manages a PASID for each command, and an internal memory device, according to an embodiment of the present disclosure.

FIG. 7 illustrates an embodiment of a computer system that includes a processor that includes a PASID management computer program that allocates and manages a PASID for each command, and an external memory device, according to an embodiment of the present disclosure.

FIG. 8 illustrates an embodiment of a computer system that includes a processor that includes a PASID allocation computer program that allocates a PASID for each command and an internal memory device that stores separated data, according to an embodiment of the present disclosure.

### DETAILED DESCRIPTION

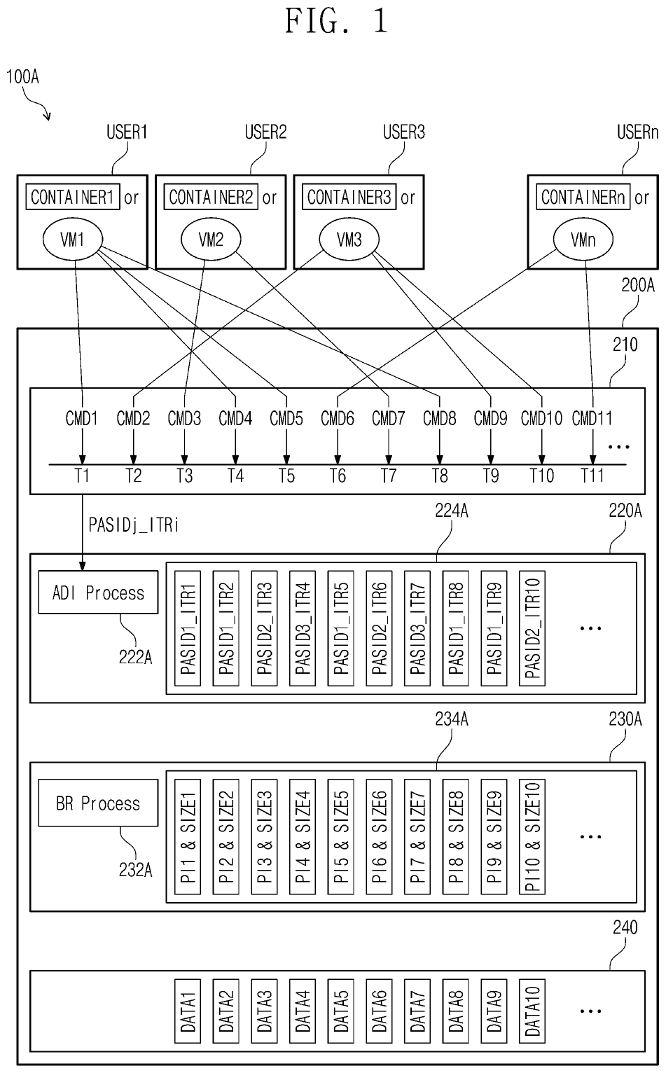

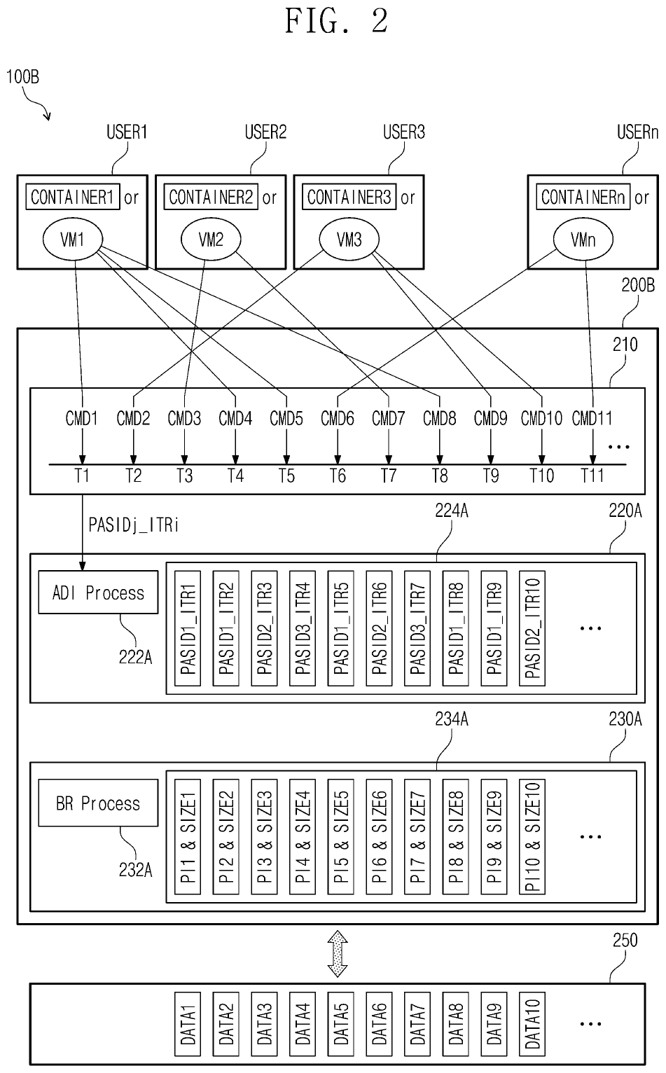

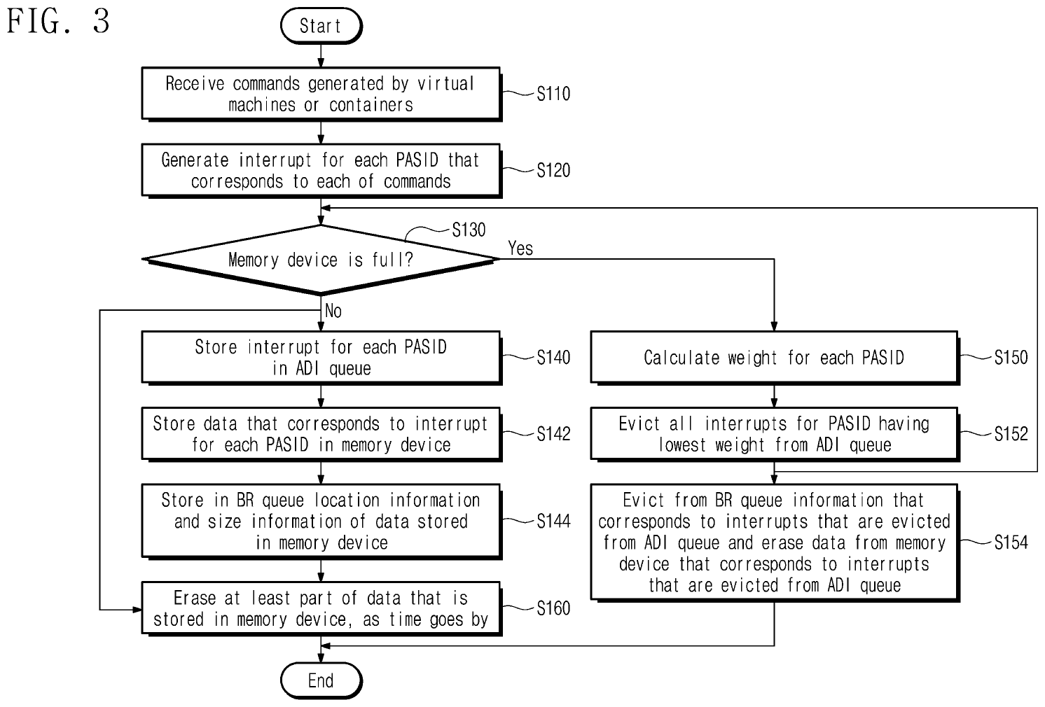

FIG. 1 illustrates an embodiment of a computer system that includes a processor that includes a PASID allocation computer program that allocates a PASID for each command, and an internal memory device, according to an embodiment of the present disclosure. FIG. 2 illustrates an embodiment of a computer system that includes a processor that includes a PASID allocation computer program that allocates a PASID for each command, and an external memory device, according to an embodiment ofthe present disclosure. FIG. 3 is a flowchart of an operation of a computer system shown in FIGS. 1, 2, 6, 7, and 8.

In the present specification, computer systems 100A, 100B, 100C, and 100D may be one of a server (or a server computer), a host, or a mobile device. In an environment that provides virtual devices USER1 to USERn, wherein ‘n’ is a positive integer greater than or equal to 4, the computer systems 100A, 100B, 100C, and 100D efficiently manage resources in processors 200A, 200B, 200C, and 200D, respectively. For example, the computer systems 100A, 100B, 100C, and 100D are server computers in a data center.

The computer systems 100A, 100B, 100C, and 100D or the processors 200A, 200B, 200C, and 200D have structures, each of which supports a single root I/O virtualization (SRIOV) specification or scalable I/O virtualization (S-IOV) specification.

A server is a computer system that provides information or services to a client through a network and includes a computer program or a device. A host is a computer that interactively communicates with other computers over the Internet. A mobile device may be one of a smartphone, a laptop computer, or a mobile internet device (MID).

Each of the virtual devices USER1 to USERn may be each computer (or each client), each of virtual devices executed in a computer, each of virtual devices executed in each computer, or each computer program (or each application) executed in a computer, but embodiments are not necessarily limited thereto.

In this specification, embodiments of a virtual device may be, for example, a virtual machine (VM) or a container, and each of the virtual devices USER1 to USERn may be a virtual machine or a container.

In an embodiment, the computer system 100A of FIG. 1 includes virtual devices USER1 to USERn and the processor 200A. The processor 200A includes a memory device 240. The computer system 100B of FIG. 2 includes the virtual devices USER1 to USERn, the processor 200B, and a memory device 250.

Except that the memory device 240 of FIG. 1 is positioned inside the processor 200A and the memory device 250 of FIG. 2 is positioned outside the processor 200B, operations of the processor 200A are the same as those of the processor 200B.

A memory device 240 that can be used as a buffer is a static random access memory (SRAM), and the memory device 250 that can be used as a buffer is a dynamic random access memory (DRAM).

When the computer system 100A, 100B, 100C, or 100D is a mobile device, the processor 200A, 200B, 200C, or 200D is an application processor (AP). When the computer system 100A, 100B, 100C, or 100D is a server or host, the processor 200A, 200B, 200C, or 200D is a memory controller.

The processor 200A includes a PASID allocation computer program 210, a first interface 220A, a second interface 230A, and the memory device 240. According to embodiments, when the processor 200A, 200B, 200C, or 200D is a memory controller, the processor may include multiple-cores, and each of the virtual devices USER1 to USERn is an OS executed in one of the multiple-cores.

Referring now to FIG. 3, the PASID allocation computer program 210 receives input/output commands CMD1 to CMD11 from the corresponding virtual devices USER1 to USERn at time points T1 to T11 (S110), respectively. The PASID allocation computer program 210 allocates (also referred to as “assigns” or “generates”) an interrupt PASIDj_ITRi, where each of ‘i’ and ‘j’ is a positive integer greater than or equal to 2, that has a PASID to each of the input/output commands CMD1 to CMD11 and outputs the PASD-specific interrupt PASIDj_rrRi to a first queue management computer program 222A of the first interface 220A (S120). The input/output command is also referred to as a “job request”. For example, the input/output command includes a read command, a write command, etc. The interrupt may correspond to a read command or correspond to a write command.

According to an embodiment, the PASID allocation computer program 210 is one of an OS, a virtual machine monitor (VMM), or a hypervisor. An embodiment is not necessarily limited thereto.

The first interface 220A includes the first queue management computer program 222A and a first queue 224A. The first queue management computer program 222A is software for an assignable device interface (ADI) process. The first queue 224A is implemented by using firmware or software. The first queue management computer program 222A is also referred to as an “ADI program” or “ADI task”.

The second interface 230A includes a second queue management computer program 232A and a second queue 234A. The second queue management computer program 232A is software for backend resources (BR) process. The second queue 234A is implemented by using firmware or software. The second queue management computer program 232A is also referred to as a “BR program” or “BR task”.

The PASID allocation computer program 210 receives the first input/output command CMD1 from the first virtual device USER1 at the first time point T1 (S110), allocates a first interrupt PASID1_ITR1 that includes a first PASID to the first input/output command CMD1, and transmits the first interrupt PASID1_ITR1 to the first queue management computer program 222A (S120).

Before storing the first interrupt PASID1_ITR1 with the first PASID in the first queue 224A, the first queue management computer program 222A determines whether the memory device 240 or 250 is full (S130).

When the memory device 240 or 250 is not full (NO in S130), the first queue management computer program 222A stores the first interrupt PASID1_ITR1 in the first queue 224A (S140).

After the first interrupt PASID1_ITR1 is stored in the first queue 224A, the second queue management computer program 232A receives the first interrupt PASID1_ITR1 from the computer program 210 or 222A and stores first data DATA1 that corresponds to the first interrupt PASID1_ITR1 in the memory device 240 or 250 (S142).

After the first data DATA1 is stored in the memory device 240 or 250, the second queue management computer program 232A stores in the second queue 234A (S144) first location information PI1 that indicates a storage location of the first data DATA1 that is stored in the memory device 240 or 250, and first size information SIZE1 that indicates a size of the first data DATA 1. According to an embodiment, operation S144 may be performed before operation S142.

The PASID allocation computer program 210 receives a second input/output command CMD2 from the third virtual device USER3 at the second time point T2(S110), allocates a second interrupt PASID1_ITR2 that includes the first PASID to the second input/output command CMD2, and transmits the second interrupt PASID1_ITR2 to the first queue management computer program 222A (S120).

Before storing the second interrupt PASID1_ITR2 in the first queue 224A, the first queue management computer program 222A determines whether the memory device 240 or 250 is full (S130).

When the memory device 240 or 250 is not full (NO in S130), the first queue management computer program 222A stores the second interrupt PASID1_ITR2 in the first queue 224A (S140).

After the second interrupt PASID1_ITR2 is stored in the first queue 224A, the second queue management computer program 232A receives the second interrupt PASID1_ITR2 from the computer program 210 or 222A and stores second data DATA2 that corresponds to the second interrupt PASID1_ITR2 in the memory device 240 or 250 (S142).

After the second data DATA2 is stored in the memory device 240 or 250, the second queue management computer program 232A stores in the second queue 234A (S144) second location information P12 that indicates a storage location of the second data DATA2 that is stored in the memory device 240 or 250, and second size information SIZE2 that indicates a size of the second data DATA2.

The PASID allocation computer program 210 receives a third input/output command CMD3 from the second virtual device USER2 at the third time point T3 (S110), allocates a third interrupt PASID2_ITR3 that includes a second PASID to the third input/output command CMD3, and transmits the third interrupt PASID2_ITR3 to the first queue management computer program 222A (S120).

Before storing the third interrupt PASID2_ITR3 in the first queue 224A, the first queue management computer program 222A determines whether the memory device 240 or 250 is full (S130).

When the memory device 240 or 250 is not full (NO in S130), the first queue management computer program 222A stores the third interrupt PASID2_ITR3 in the first queue 224A (S140).

After the third interrupt PASID2_ITR3 is stored in the first queue 224A, the second queue management computer program 232A receives the third interrupt PASID2_ITR3 from the computer program 210 or 222A and stores third data DATA3 that corresponds to the third interrupt PASID2_ITR3 in the memory device 240 or 250 (S142).

After the third data DATA3 is stored in the memory device 240 or 250, the second queue management computer program 232A stores in the second queue 234A (S144) third location information P13 that indicates a storage location of the third data DATA3 that is stored in the memory device 240 or 250, and third size information SIZE3 that indicates a size of the third data DATA3.

The PASID allocation computer program 210 receives the fourth input/output command CMD4 from the first virtual device USER1 at the fourth time point T4 (SI 10), allocates a fourth interrupt PASID3_ITR4 that includes a third PASID to the fourth input/output command CMD4, and transmits the fourth interrupt PASID3_ITR4 to the first queue management computer program 222A (S120).

Before storing the fourth interrupt PASID3_ITR4 in the first queue 224A, the first queue management computer program 222A determines whether the memory device 240 or 250 is full (S130).

When the memory device 240 or 250 is not full (NO in S130), the first queue management computer program 222A stores the fourth interrupt PASID3_ITR4 in the first queue 224A (S140).

After the fourth interrupt PASID3_ITR4 is stored in the first queue 224A, the second queue management computer program 232A receives the fourth interrupt PASID3_ITR4 from the computer program 210 or 222A and stores fourth data DATA4 that corresponds to the fourth interrupt PASID3_ITR4 in the memory device 240 or 250 (S142).

The second queue management computer program 232A stores in the second queue 234A (S144) fourth location information P14 that indicates a storage location of the fourth data DATA4 that is stored in the memory device 240 or 250, and fourth size information SIZE4 that indicates a size of the fourth data DATA4.

The PASID allocation computer program 210 receives the input/output commands CMD5 to CMD10 from corresponding virtual devices at time points T5 to T10, respectively (S110). The PASID allocation computer program 210 respectively allocates interrupts PASID1_ITR5, PASID2_ITR6, PASID3_ITR7, PASID1_ITR8, PASID1_ITR9, and PASID2_ITR10, each of which includes a corresponding PASID, with respect to the input/output commands CMD5 to CMD10, and transmits the interrupts PASID1_ITRS, PASID2_ITR6, PASID3_ITR7, PASID1_ITR8, PASID1_ITR9, and PASID2_ITR10, each of which includes the corresponding PASID, to the first queue management computer program 222A (S120).

Before storing the corresponding interrupts PASID1_ITR5, PASID2_ITR6, PASID3_ITR7, PASID1_ITR8, PASID1_ITR9, and PASID2_ITR 10 in the first queue 224A, the first queue management computer program 222A determines whether the memory device 240 or 250 is full (S130).

When the memory device 240 or 250 is not full (NO in S130), the first queue management computer program 222A sequentially stores the corresponding interrupts PASID1_ITRS, PASID2_ITR6, PASID3_ITR7, PASID1_ITR8, PASID1_ITR9, and PASID2_ITR10 in the first queue 224A (S140).

The second queue management computer program 232A receives the corresponding interrupts PASID1_ITR5, PASID2_ITR6, PASID3_ITR7, PASID1_ITR8, PASID1_ITR9, and PASID2.ITR10 from the computer program 210 or 222A and stores data DATA5 to DATA10 that respectively corresponds to the PASID-specific interrupts PASID1_ITR5, PASID2_ITR6, PASID3_ITR7, PASID1_ITR8, PASID1_ITR9, and PASID2_ITR10 in the memory device 240 or 250 (S142).

After each of the data DATA5 to DATA 10 are stored in the memory device 240 or 250, the second queue management computer program 232A stores in the second queue 234A (S144) location information P15 to PI10 that respectively indicates storage locations of the data DATA5 to DATA10 that are stored in the memory device 240 or 250, and size information SIZES to SIZE10 respectively indicating sizes of the data DATA5 to DATA10.

For example, each of the storage locations PI1 to P10 is a start address of a storage space (or a memory space) of the memory device 240 or 250. A size of each of data DATA5 to DATA10 is expressed in units of bytes.

For example, the second queue management computer program 232A performs a read operation or a write operation based on the PASID-specific interrupts PASID1_ITR1, PASID1_ITR2, PASID2_ITR3, PASID3_ITR4, PASID1_ITR5, PASID2_ITR6, PASID3_ITR7, PASID1_ITR8, PASID1_ITR9, and PASID2_ITR10.

When each of the input/output commands CMD1 to CMD10 is a read command, the second queue management computer program 232A reads the data DATA1 to DATA10 from a memory device, such as a hard disk drive (HDD) or solid state drive (SSD), depending on the read operation, and stores the data DATA1 to DATA10 in the memory device 240 or 250. When each of the input/output commands CMD1 to CMD10 is a write command, the second queue management computer program 232A receives each of the data DATA1 to DATA10 from the corresponding virtual devices USER1 to USERn and stores the data DATA1 to DATA 10 in the memory device 240 or 250, respectively.

The PASID allocation computer program 210 receives the eleventh input/output command CMD11 output from the n-th virtual device USERn at the eleventh time point T11 (S110) and allocates an eleventh interrupt PASID1_ITR11 that includes the first PASID to the eleventh input/output command CMD11 (S120).

Before storing the eleventh interrupt PASID1_ITR11 in the first queue 224A, the first queue management computer program 222A determines whether the memory device 240 or 250 is full (S130).

When the memory device 240 or 250 is full (YES in S130), the first queue management computer program 222A calculates a weight for each PASID (S150).

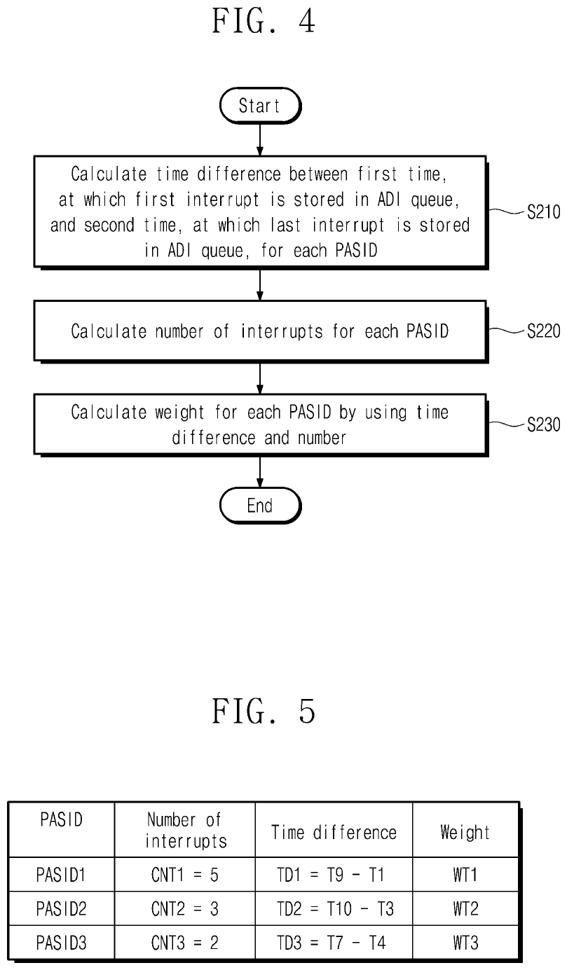

FIG. 4 is a flowchart of a method of calculating a weight by using a first queue management computer program executed in a processor, according to an embodiment of the present disclosure. FIG. 5 shows an embodiment of a weight calculated by using a first queue management computer program executed in a processor, according to an embodiment of the present disclosure.

Referring to FIGS. 4 and 5, in an embodiment, the first queue management computer program 222A calculates a time difference between a first time, at which a first interrupt is stored in the first queue 224A, and a second time, at which a last interrupt is stored in the first queue 224A, for each PASID (S210).

The first queue management computer program 222A calculates the number of interrupts stored in the first queue 224A for each PASID (S220).

The first queue management computer program 222A calculates a weight for each PASID by using the time difference calculated in operation S210 and/or the number calculated in operation S220 (S230). For example, as the time difference calculated in operation S210 increases and the number calculated in operation S220 increases, the weight increases.

According to an embodiment, the first queue management computer program 222A calculates a weight for each PASID by using at least one of the time difference calculated in operation S210 or the number calculated in operation S220 (S230).

As shown in FIG. 5, in an embodiment, a first time difference TDI for the first PASID PASID1 is a difference between the ninth time point T9 and the first time point T1; the number CNT1 of interrupts for the first PASID PASID1 is ‘5’; and a first weight WT1 for the first PASID PASID1 is determined based on the first time difference TD1 and the number CNT1.

A second time difference TD2 for the second PASID PASID2 is a difference between the tenth time point T10 and the third time point T3; the number CNT2 of interrupts for the second PASID PASID2 is ‘3’; and a second weight WT2 for the second PASID PASID2 is determined based on the second time difference TD2 and the number CNT2.

A third time difference TD3 for the third PASID PASID3 is a difference between the seventh time point T7 and the fourth time point T4; the number CNT3 of interrupts for the third PASID PASID3 is ‘2’; and a third weight WT3 for the second PASID PASID3 is determined based on the third time difference TD3 and the number CNT3.

In an embodiment, it is assumed that the first weight WT1 is greater than the second weight WT2, and the second weight WT2 is greater than the third weight WT3.

When the memory device 240 or 250 is full (YES in SI30), the first queue management computer program 222A evicts all interrupts for the PASID that have the lowest weight from the first queue 224A (SI52), evicts from the second queue 234A information that corresponds to the interrupts that have been evicted from the first queue 224A, and erases from the memory device 240 or 250 (S154) data that corresponds to the interrupts that have been evicted from the first queue 224A.

According to an embodiment, operation S154 may be performed by the second queue management computer program 232A under control of the first queue management computer program 222A.

For example, because the third weight WT3 for the third PASID PASID3 is the lowest, the first queue management computer program 222A evicts interrupts PASID3_ITR4 and PASID3_ITR7 from the first queue 224A (S152), evicts from the second queue 234A information P14, SIZE4, P17, and SIZE7 that corresponds to the interrupts PASID3_ITR4 and PASID3_ITR7 that have been evicted from the first queue 224A, and erases from the memory device 240 or 250 (S154) the data DATA4 and DATA7 that corresponds to the interrupts PASID3_ITR4 and PASID3_ITR7 that have been evicted from the first queue 224A.

Even when the memory device 240 or 250 is not full (NO in S130), the second queue management computer program 232A erases at least part of data that is stored in the memory device 240 or 250 as time goes by (S160). For example, the second queue management computer program 232A erases all or part of the first data DATA 1 stored in the memory device 240 or 250.

Even when all or part of the first data DATA1 is erased from the memory device 240 or 250, the second queue management computer program 232A can read all or part of the first data DATA1 stored in a HID or SSD again and can store the read data in the memory device 240 or 250.

FIGS. 1 and 2 illustrate that each of the computer programs 210, 222A, and 232A are separate from each other. However, in an embodiment, each of the computer programs 210, 222A, and 232A is a part of one computer program that assigns a PASID and manages the queues 224A and 234A.

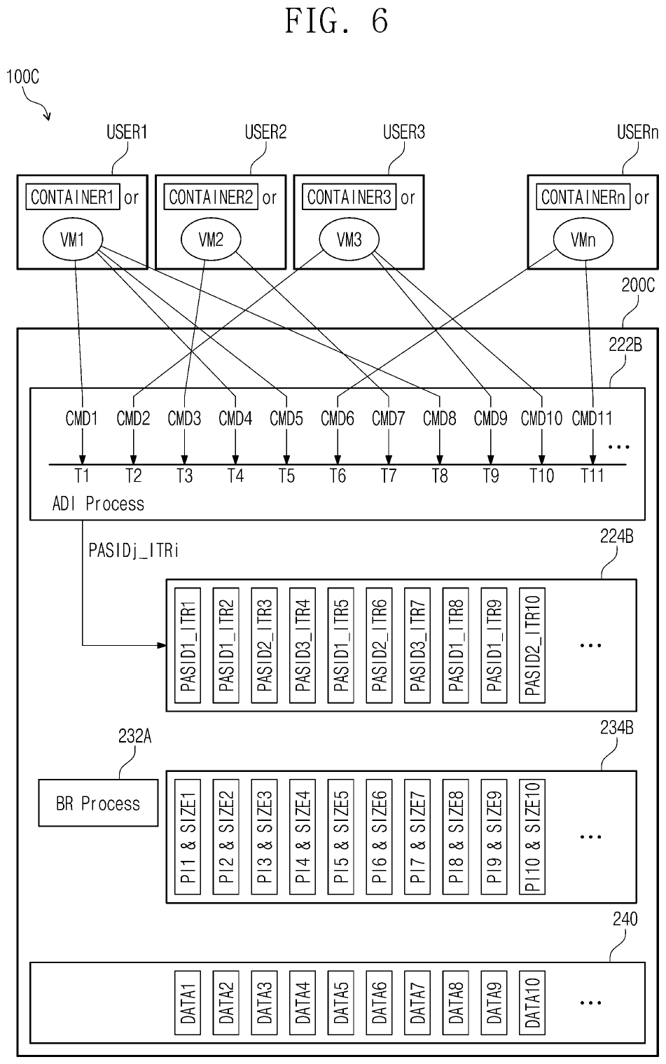

FIG. 6 illustrates an embodiment of a computer system that includes a processor that includes a PASID management computer program that allocates and manages a PASID for each command, and an internal memory device, according to an embodiment of the present disclosure.

As understood from a comparison of FIGS. 1 and 6, in FIG. 1, the PASID allocation computer program 210 generates the PASID-specific interrupt PASIDj_ITRi for each input/output command, and the first queue management computer program 222A manages the first queue 224A such that the first queue 224A stores the PASID-specific interrupt PASIDj_ITRi. On the other hand, in FIG. 6, a PASID management computer program 222B generates the PASID-specific interrupt PASIDj_ITRi for each input/output command and manages a first hardware queue 224B such that the first hardware queue 224B stores the PASID-specific interrupt PASIDj_ITRi.

In addition, in FIG. 1, each of the queues 224A and 234A is a software queue or a firmware queue. However, in FIG. 6, each of queue 224B and 234B is a hardware queue.

Referring to FIG. 6, in an embodiment, the processor 200C includes the PASID management computer program 222B, the first hardware queue 224B, a second queue management computer program 232A, the second hardware queue 234B, and the memory device 240.

The PASID management computer program 222B respectively receives the input/output commands CMD1 to CMD10 from corresponding virtual devices at the time points T1 to T10 (S110) and respectively allocates the interrupts PASID_ITR1, PASID1_ITR2, PASID2_TR3, PASID3_ITR4, PASID1_ITR5, PASID2_ITR6, PASID3_ITR7, PASID1_ITR8, PASID1_ITR9, and PASID2_ITR10, each of which includes the corresponding PASID, to the input/output commands CMD1 to CMD10 (S120).

Before storing the interrupts PASID1_ITR1, PASID1_ITR2, PASID2_ITR3, PASID3_ITR4, PASID1_ITR5, PASID2_ITR6, PASID3_ITR7, PASID1_ITR8, PASID1_ITR9, and PASID2_ITR10 in the first hardware queue 224B, the PASID management computer program 222B determines whether the memory device 240 or 250 is full (S130).

When the memory device 240 or 250 is not full (NO in S130), the PASID management computer program 222B sequentially stores the interrupts PASID1_ITR1, PASID1_ITR2, PASID2_ITR3, PASID3_ITR4, PASID1_ITRS, PASID2_ITR6, PASID3_ITR7, PASID1_ITR8, PASID1_ITR9, and PASID2_ITR 10 in the first hardware queue 224B (S140).

After the interrupts PASID1_ITR1, PASID1_ITR2, PASID2_ITR3, PASID3_ITR4, PASID1_ITR5, PASID2_ITR6, PASID3_rrR7, PASID1_ITR8, PASID1_rrR9, and PASID2_ITR10 are sequentially stored in the first hardware queue 224B, the second queue management computer program 232A stores the data DATA1 to DATA10 that respectively corresponds to the interrupts PASID1_ITR1, PASID1_ITR2, PASID2_ITR3, PASID3_ITR4, PASID1_ITR5, PASID2_ITR6, PASID3_ITR7, PASID1_ITR8, PASID1_ITR9, and PASID2.ITR10 in the memory device 240 or 250 (S142).

The second queue management computer program 232A stores in the second hardware queue 234B (S144) location information PI1 to PI10 that respectively indicates storage locations of the data DATA1 to DATA 10 that are stored in the memory device 240 or 250, and size information SIZE1 to SIZE10 that respectively indicates sizes of the data DATA1 to DATA10.

The PASID management computer program 222B receives the eleventh input/output command CMD11 from the n-th virtual device USERn at the eleventh time point T11 (S110) and allocates the eleventh interrupt PASID1_ITR11 that includes the first PASID to the eleventh input/output command CMD11 (S120).

Before storing the eleventh interrupt PASID1_ITR11 in the first hardware queue 224B, the PASID management computer program 222B determines whether the memory device 240 or 250 is full (S130).

When the memory device 240 or 250 is full(YES in S130), the PASID management computer program 222B calculates a weight for each PASID (S150).

According to an embodiment, the PASID management computer program 222B calculates a weight for each PASID by using at least one of the time difference calculated in operation S210 or the number calculated in operation S220 (S230).

When the memory device 240 or 250 is full (YES in S130), the PASID management computer program 222B evicts from the first hardware queue 224B (S152) all interrupts for the PASID that have the lowest weight, evicts from the second hardware queue 234B information that corresponds to the interrupts that have been evicted from the first hardware queue 224B, and erases from the memory device 240 or 250 (S154) data that corresponds to the interrupts that have been evicted from the first hardware queue 224B.

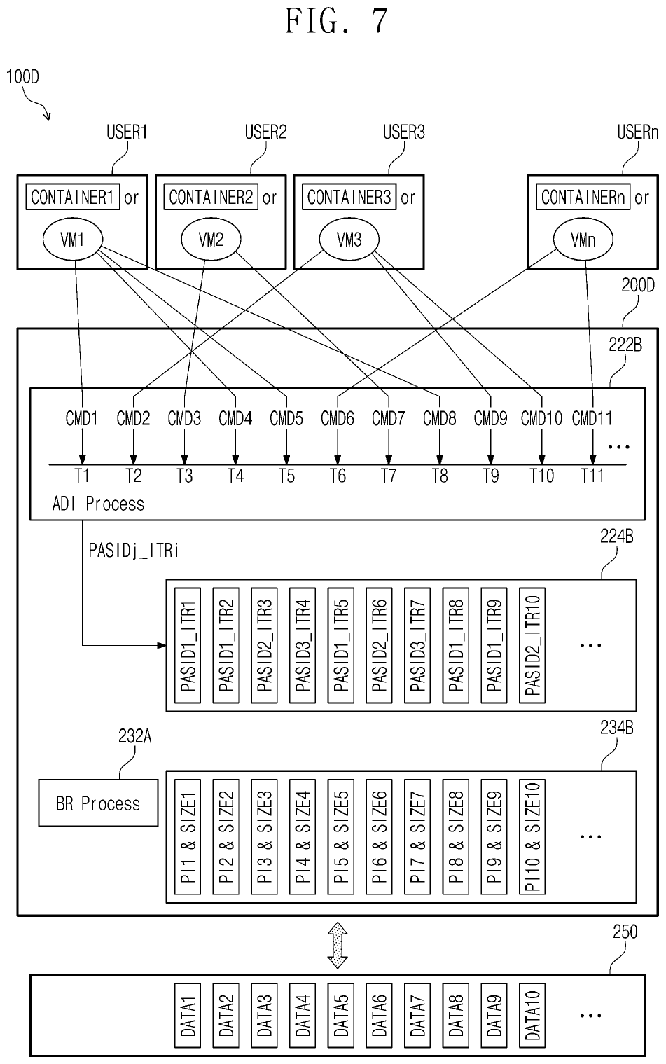

FIG. 7 illustrates an embodiment of a computer system that includes a processor that includes a PASID management computer program that allocates and manages a PASID for each command, and an external memory device, according to an embodiment of the present disclosure. Except that the memory device 240 of FIG. 6 is positioned inside the processor 200C and the memory device 250 of FIG. 7 is positioned outside the processor 2001), operations of the processor 200C of the computer system 100C in FIG. 6 are the same as those of the processor 200D of the computer system 100D in FIG. 7.

FIGS. 6 and 7 illustrate that each of the computer programs 222B and 232A are separate from one another. However, in an embodiment, each of the computer programs 222B and 232A is a part of one computer program that assigns a PASID and manages the queues 224B and 234B

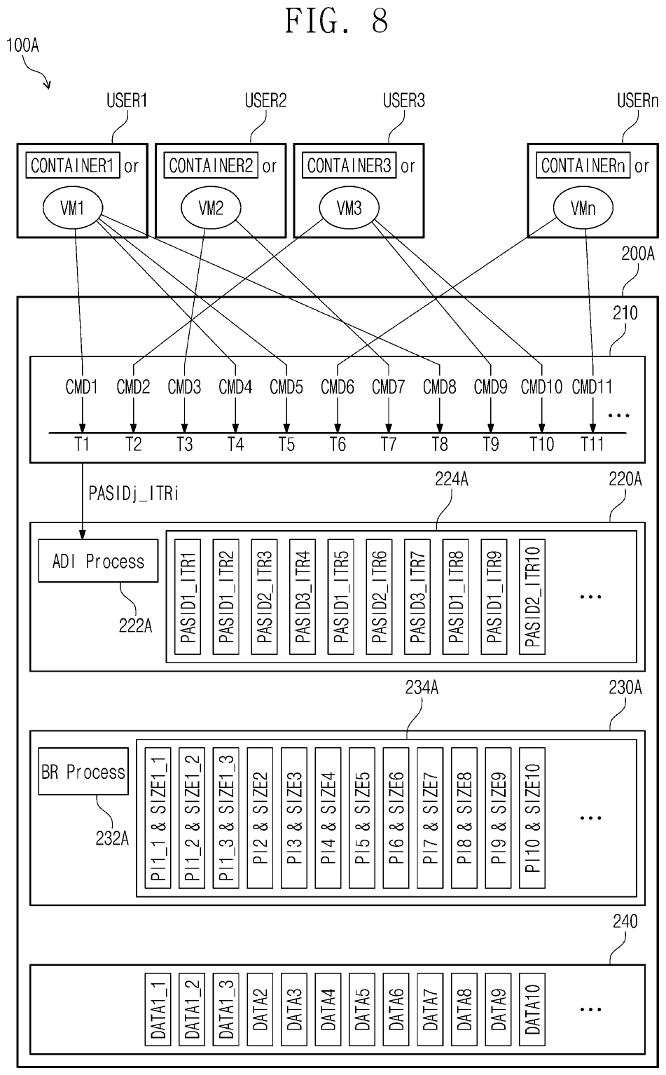

FIG. 8 illustrates an embodiment of a computer system that includes a processor that includes a PASID allocation computer program that allocates a PASID for each command and an internal memory device that stores separated data, according to an embodiment of the present disclosure.

Referring to FIGS. 1 and 8, in an embodiment, the first data DATA1 is divided into pieces of data DATA1_1, DATA1_2, and DATA1_3, and the pieces of data DATA1_1, DATA1_2, and DATA1_3 are stored in the memory device 240.

The PASID allocation computer program 210 receives the first input/output command CMD1 from the first virtual device USER1 at the first time point T1 (SI 10), allocates the first interrupt PASID1_ITR1 that includes a first PASID to the first input/output command CMD1, and transmits the first interrupt PASID1_ITR1 to the first queue management computer program 222A (S120).

Before storing the first interrupt PASID1_ITR1 in the first queue 224A, the first queue management computer program 222A determines whether the memory device 240 or 250 is full (S130).

When the memory device 240 or 250 is not full (NO in S130), the first queue management computer program 222A stores the first interrupt PASID1_ITR1 in the first queue 224A (S140).

After the first interrupt PASID1_ITR1 is stored in the first queue 224A, the second queue management computer program 232A divides the first data DATA1 that corresponds to the first interrupt PASID1_TR1 into the pieces of data DATA1_1, DATA1_2, and DATA1_3 and stores the pieces of data DATA1_1, DATA1_2, and DATA1_3 in the memory device 240(S142).

After the pieces of data DATA1_1, DATA1_2, and DATA1_3 are stored in the memory device 240, the second queue management computer program 232A stores in the second queue 234A (S144) location information PI1_1, PI1_2, and PI1_3 that respectively indicate storage locations of the pieces of data DATA1_1, DATA1_2, and DATA1_3 that are stored in the memory device 240, and size information SIZE1_1, SIZE1_2, and SIZE1_3 that respectively indicate sizes of the pieces of data DATA1_1, DATA 1_2, and DATA1_3.

Each of the processors 200B, 200C, and 200D can divide the corresponding data into pieces of data, store the pieces of data in the memory device 240 or 250, and store in the corresponding queue 234A or 234B and manage location information about the pieces of data and size information about the pieces of data.

In this specification, the above-described computer programs 210,222A, 2228, and 232A are a sequence of instructions or a set of instructions that are implemented by using a programming language that the computer systems 100A, 100B, 100C, and 001D or the processors 200A, 200B, 200C, and 200D can execute or interpret.

Accordingly, according to an embodiment of the present disclosure, each of the computer programs 210, 222A, 222B, and 232A that include a sequence of instructions that execute a method for managing resources by using the processor 200A, 200B, 200C, or 200D, each of which has the first queue 224A or 224B and the second queue 234A or 234B, is stored in a non-transitory computer readable medium.

For example, the resources are information (or data) stored in the first queue 224A or 224B and the second queue 234A or 234B.

The medium may be a memory device that can be accessed (e.g., read or written) by the processor 200A, 200B, 200C, or 200D as a storage medium. The memory device may be positioned inside or outside the processor 200A, 200B, 200C, or 200D.

Embodiments of the present disclosure has been described with reference to one embodiment shown in the drawings, and it will be understood that various modifications and other equivalent embodiments are possible by those skilled in the art. The technical protection scope of embodiments of the present disclosure will be defined by the technical spirit of the appended claims.

According to an embodiment of the present disclosure, a processor that includes dual queues can efficiently manage resource(s) associated with an interrupt that includes a PASID that corresponds to an input/output command received from an individual virtual device by using the dual queues.

A processor that includes dual queues according to an embodiment of the present disclosure can count the number of interrupts for each PASID, assign a weight to each PASID based on the number of interrupts calculated for each PASID, and determine whether to evict interrupts that have a corresponding PASID depending on the weight thus assigned.

While embodiments of the present disclosure have been described with reference to the drawings, it will be apparent to those of ordinary skill in the an that various changes and modifications may be made thereto without departing from the spirit and scope of embodiments of the present disclosure as set forth in the following claims.

What is claimed is:

1. A method for managing resources by using a processor that includes a first queue and a second queue, the method comprising:
receiving, by the processor, input/output commands from a virtual device;
generating, by the processor, interrupts that each includes a process address space identifier (PASID) that corresponds to one of the input/output commands;
storing, by the processor, the interrupts in the first queue;
storing, by the processor, in a memory device, data that respectively corresponds to each of the interrupts; and
storing, by the processor, in the second queue, location information that indicates a storage location of the respective data stored in the memory device and size information that indicates a size of the respective data.

2. The method of claim 1, wherein storing the interrupts in the first queue includes:
determining, by the processor, whether the memory device is full; and
when the memory device is not full, storing, by the processor, the interrupts in the first queue.

3. The method of claim 1, further comprising:
erasing, by the processor, all or part of data that is stored in the memory device.

4. The method of claim 2, further comprising:
when the memory device is full, determining, by the processor, interrupts to be evicted from the interrupts stored in the first queue;
evicting, by the processor, the determined interrupts from the first queue;
evicting, by the processor, location information and size information that correspond to each of the interrupts evicted from the first queue from the second queue; and
erasing, by the processor, data that corresponds to each of the evicted interrupts from the memory device.

5. The method of claim 4, wherein determining the interrupts to be evicted includes:
calculating, by the processor, a number of interrupts for each PASID that are stored in the first queue; and
determining, by the processor, as the interrupts to be evicted those interrupts that correspond to a PASID having a smallest number of interrupts calculated for each PASID.

6. The method of claim 4, wherein determining the interrupts to be evicted includes:
calculating, by the processor, a time difference between a storage time of a first interrupt and a storage time of a last interrupt for each PASID of the interrupts stored in the first queue; and
determining, by the processor, the interrupts to be evicted by using the time difference calculated for each PASID.

7. The method of claim 1, wherein each of the first queue and the second queue is implemented by using software or by using hardware.

8. The method of claim 1, wherein the processor supports a scalable I/O virtualization (S-IOV) specification.

9. The method of claim 1, wherein each of the virtual devices is a virtual machine or a container.

10. The method of claim 1, wherein, when the memory device is included inside the processor, the memory device is a static random access memory (SRAM), and
when the memory device is positioned outside the processor, the memory device is a dynamic random access memory (DRAM).

11. A processor, comprising:
a first queue and a second queue,
wherein the processor executes a process address space identifier (PASID) allocation computer program, a first queue management computer program, and a second queue management computer program.
wherein the PASID allocation computer program receives input/output commands from virtual devices and generates interrupts that each include a PASID that corresponds to one of the input/output commands,
wherein the first queue management computer program receives the interrupts generated by the PASID allocation computer program and stores the interrupts in the first queue, and wherein the second queue management computer program stores, in a memory device, data that respectively corresponds to each of the interrupts in response to each of the interrupts received from the PASID allocation computer program or the first queue management computer program, and stores in the second queue location information that indicates a storage location of the data that is stored in the memory device, and size information that indicates a size of the data.

12. The processor of claim 11, wherein the first queue management computer program determines whether the memory device is full, and stores the interrupts in the first queue when the memory device is not full, and
the second queue management computer program erases all or part of data from the data stored in the memory device.

13. The processor of claim 12, wherein, when the memory device is full, the first queue management computer program determines interrupts to be evicted from interrupts stored in the first queue and evicts the determined interrupts from the first queue, and
wherein one of the first queue management computer program or the second queue management computer program evicts location information and size information that correspond to each of the evicted interrupts from the second queue, and erases data that corresponds to each of the evicted interrupts from the memory device.

14. The processor of claim 13, wherein the first queue management computer program calculates a number of interrupts for each PASID stored in the first queue and determines those interrupts that correspond to a PASID that has a smallest number of interrupts calculated for each PASID as the interrupts to be evicted.

15. The processor of claim 13, wherein the first queue management computer program calculates a time difference between a storage time of a first interrupt and a storage time of a last interrupt for each PASID of the interrupts stored in the first queue and determines those interrupts to be evicted by using the time difference calculated for each PASID.

16. A processor, comprising:
a process address space identifier (PASID) management computer program, a second queue management computer program, a first hardware queue, and a second hardware queue,
wherein the PASID management computer program receives input/output commands from virtual devices, generates interrupts that each include a PASID that corresponds to each of the input/output commands, and stores the interrupts in the first hardware queue, and
wherein the second queue management computer program stores data that respectively corresponds to each of the interrupts in a memory device in response to each of the interrupts received from the PASID management computer program, and stores, in the second hardware queue, location information that indicates a storage location of the data that is stored in the memory device, and size information that indicates a size of the respective data.

17. The processor of claim 16, further comprising a first queue management computer program, wherein the first queue management computer program determines whether the memory device is full, and stores the interrupts in the first queue when the memory device is not full, and
the second queue management computer program erases all or part of data from the data stored in the memory device.

18. The processor of claim 17, wherein, when the memory device is full, the first queue management computer program determines interrupts to be evicted from the interrupts stored in the first queue and evicts the determined interrupts from the first queue, and
wherein one of the first queue management computer program or the second queue management computer program evicts location information and size information that correspond to each of the evicted interrupts from the location information and the size information stored in the second queue, and erases data that corresponds to each of the evicted interrupts from the memory device.

19. The processor of claim 18, wherein the first queue management computer program calculates a number of interrupts for each PASID of the interrupts stored in the first queue and determines interrupts that corresponds to a PASID that has a smallest number of interrupts calculated for each PASID as the interrupts to be evicted.

20. The processor of claim 18, wherein the first queue management computer program calculates a time difference between a storage time of a first interrupt and a storage time of a last interrupt for each PASID of the interrupts stored in the first queue and determines the interrupts to be evicted by using the time difference calculated for each PASID.
